(19) United States
(12) Patent Application Publication
(10) Pub. No.: US 2026/0122143 A1
(43) Pub. Date: Apr. 30, 2026

(54) SYSTEMS AND METHODS FOR ORCHESTRATING TRANSACTION MESSAGES USING MICROSERVICE-BASED ARCHITECTURE

(71) Applicant: AMADEUS S.A.S., Biot (FR)

(72) Inventors: Mathieu LE MARIER, Geneva (CH); David SAMAK, Nice (FR); Antonin GUEROULT, Biot (FR); Nicolas GEX, Marcy L’Etoile (FR); Marzia MARMORE, Antibes (FR); Paolo BARCARO, Antibes (FR)

(21) Appl. No.: 19/235,426

(22) Filed: Jun. 11, 2025

(30) Foreign Application Priority Data
Oct. 30, 2024 (EP) 24315502

(51) Int. Cl. H04L 67/51; G06Q 40/03; H04L 41/147

(52) U.S. Cl. CPC H04L 67/51; H04L 41/147; G06Q 40/03

(57) ABSTRACT

The present specification relates to systems and methods for processing transaction messages in distributed computing environments. The disclosed system includes an orchestration engine that interacts with a plurality of computing engines and micro-services to manage different aspects of transaction messages. The orchestration engine receives transaction data, identifies relevant services, determines their availability, and coordinates their execution to complete processing tasks. The system's architecture allows for dynamic adjustment of service prioritization and resource allocation based on real-time conditions, enhancing the efficiency of handling transaction messages. Additionally, caching mechanisms store service availability information to reduce processing overhead in subsequent transactions. The described methods facilitate improved coordination among computing engines, supporting scalability and adaptability in diverse transaction processing scenarios.

### CROSS-REFERENCE TO RELATED APPLICATION

This application claims priority from European Application No. 24315502, filed Oct. 30, 2024, which is also incorporated herein by reference in its entirety.

### FIELD

The present specification relates generally to systems and methods for transaction processing in distributed computing environments. More specifically, it pertains to orchestrating transaction messages using microservice-based architectures.

### BACKGROUND

In distributed computing environments, different computing engines manage various aspects of transaction messages. As these environments scale, with increasing numbers of computing engines handling numerous transactions, resource allocation and coordination challenges grow increasingly exponentially. At a global level, where millions of transaction messages are processed daily, these complexities can further strain the capacity of existing systems, leading to inefficiencies in managing data throughput and balancing computational loads. Furthermore, the variability in electronic transaction processing-spanning different sequences and computations for electronic validation, authorization, and related processes-further contributes to the heterogeneity of the system and associated limitations.

### SUMMARY

An aspect of the specification provides a system for processing a credit-message request, the system including: an orchestration engine configured to receive a credit-message request; a parser configured to extract transaction details from the credit-message request; a micro-service identification module configured to identify one or more micro-services required to process the extracted transaction details; a micro-service availability module configured to determine the availability of the identified micro-services by: calling the selected micro-service to perform its respective function; processing the response received from the called micro-service; repeating the determining, calling, and processing for the remainder of the identified micro-services; a confirmation module configured to generate a confirmation for the processed credit-message request; and, an output device controller configured to control an output device based on the confirmation of the processed credit-message request.

An aspect of the specification provides a system, wherein the micro-service availability module is further configured to: load prioritization rules for the micro-services; determine the queue status of each identified micro-service; assess the load on each identified micro-service; update the prioritization of the micro-services based on their current load and queue status; and, select the next micro-service to call based on the updated prioritization.

An aspect of the specification provides a system, further including a prioritization adjustment module configured to dynamically adjust the prioritization rules based on one or more of real-time system load conditions, geographic location of the transaction, and transaction-specific parameters.

An aspect of the specification provides a system, further including a prediction module configured to predict future network traffic bottlenecks based on historical transaction patterns and dynamically adjust the micro-service prioritization in anticipation of future demand.

An aspect of the specification provides a system, wherein the parser is further configured to normalize the transaction details to a predefined format to ensure compatibility with the micro-service interfaces.

An aspect of the specification provides a system, further including a machine learning module configured to analyze historical transaction data and adjust the prioritization rules to optimize resource utilization and minimize latency in subsequent transactions.

An aspect of the specification provides a system, wherein the output device controller is further configured to generate and send an electronic message to a client device or administrator terminal indicating the status and results of the processed credit-message request.

An aspect of the specification provides a system, wherein the micro-service availability module is further configured to: query each micro-service for system load, response time, and maintenance status; and, dynamically select an alternative micro-service if the first identified service is unavailable.

An aspect of the specification provides a system, further including: a cache configured to store the availability status of one or more micro-services; and, a caching module configured to use the cached availability status during the determining step of a subsequent credit-message request such that fewer processing resources are used while processing the subsequent request.

An aspect of the specification provides a system, further including a fraud detection module configured to invoke fraud detection micro-services to assess the risk profile of the transaction based on cross-referenced user behavior, transaction history, and external risk databases before completing the credit-message request.

An aspect of the specification provides a computer-implemented method for processing a credit-message request via an orchestration engine, the method including: receiving a credit-message request at the orchestration engine; parsing the received request to extract transaction details; identifying one or more micro-services required to process the extracted transaction details; determining the availability of the identified micro-services by: calling the selected micro-service to perform its respective function; processing the response received from the called micro-service; repeating the determining, calling, and processing for the remainder of the one or more micro-services; generating a confirmation for the processed credit-message request; and, controlling an output device based on the confirmation of the processed credit-message request.

An aspect of the specification provides a method, wherein the determining includes: loading prioritization rules for the micro-services; determining the queue status of each identified micro-service; assessing the load on each identified micro-service; updating the prioritization of the micro-services based on their current load and queue status; and, selecting the next micro-service to call based on the updated prioritization.

An aspect of the specification provides a method, further including dynamically adjusting the prioritization rules based on one or more of real-time system load conditions, geographic location of the transaction, and transaction-specific parameters.

An aspect of the specification provides a method, further including predicting future network traffic bottlenecks based on historical transaction patterns and dynamically adjusting the micro-service prioritization in anticipation of future demand.

An aspect of the specification provides a method, wherein the parsing of the credit-message request includes normalizing the transaction details to a predefined format to ensure compatibility with the micro-service interfaces.

An aspect of the specification provides a method, further including invoking a machine learning model to analyze historical transaction data and adjust the prioritization rules to optimize resource utilization and minimize latency in subsequent transactions.

An aspect of the specification provides a method, wherein the controlling of the output device includes generating and sending an electronic message to a client device or administrator terminal indicating the status and results of the processed credit-message request.

An aspect of the specification provides a method, wherein determining the availability of the identified micro-services includes querying each micro-service for system load, response time, and maintenance status, and dynamically selecting an alternative micro-service if the first identified service is unavailable.

An aspect of the specification provides a method, further including: caching the availability status of one or more micro-services; and, using the cached availability status during the determining step of a subsequent credit-message request such that fewer processing resources are used while processing the subsequent credit-message request than were used while processing the first credit-message request.

An aspect of the specification provides a method, further including invoking fraud detection micro-services to assess the risk profile of the transaction based on cross-referenced user behavior, transaction history, and external risk databases before completing the credit-message request. The present specification also contemplates methods, systems, apparatuses and computer readable media according to the foregoing.

### BRIEF DESCRIPTION OF THE FIGURES

The present specification includes the attached Figures, in which:

FIG. 1 shows a system for orchestrating transaction messages using microservice-based architecture.

FIG. 2 shows a schematic diagram of a non-limiting example of internal components of the orchestrator engine of FIG. 1.

FIG. 3 shows a schematic diagram of a non-limiting example of a stack of components associated with the engine of FIG. 2.

FIG. 4 shows a flowchart depicting a method for orchestrating transaction messages using microservice-based architecture.

FIG. 5 shows a flowchart depicting a method for determining micro-service prioritization based on system load and availability.

### DETAILED DESCRIPTION

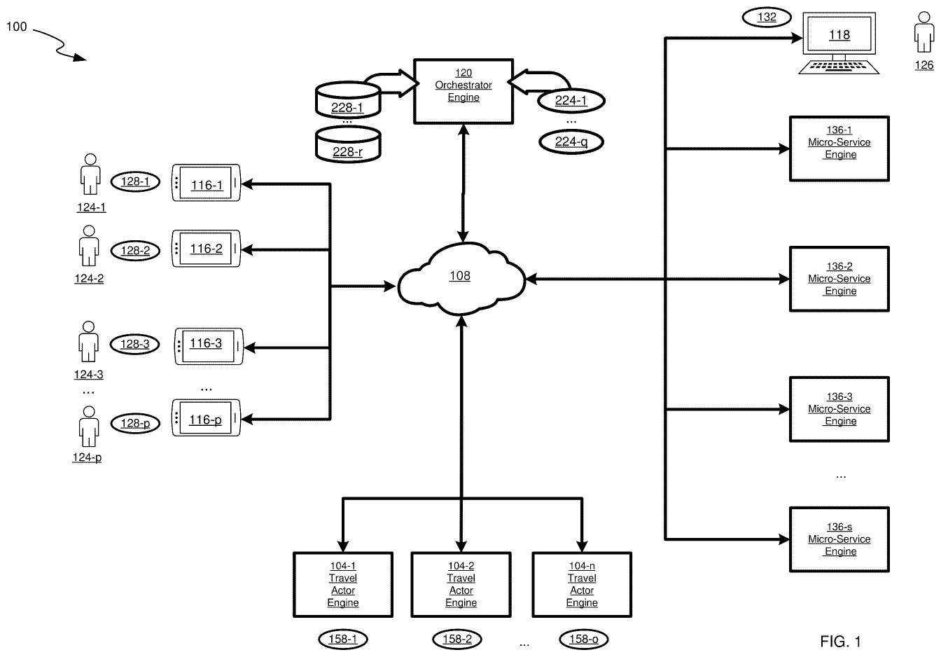

FIG. 1 shows a system for orchestrating transaction messages indicated generally at 100. System 100 comprises a plurality of travel actor engines 104-1, 104-2 . . . 104-n. (Collectively, engines 104-1, 104-2 . . . 104-n are referred to as engines 104, and generically, as engine 104. This nomenclature is used elsewhere herein.) In system 100, engines 104 connect to a network 108 such as the Internet. Network 108 interconnects travel actor engines 104 with a plurality of client devices 116, at least one administrator terminal 118 and an orchestrator engine 120.

Each client device 116 corresponds to a different user 124, with an identifier object 128 associating each user 124 with its respective device 116. Similarly, management terminal 118 corresponds to a system administrator 126. An identifier object 132 associates administrator 126 with management terminal 118.

Additionally, orchestrator engine 120 is connected, via network 108, to a plurality of micro-service engines 136. Each micro-service engine 136 is responsible for responding to different aspects of transaction messages, each typically executing a distinct operation, such as payment authorization, fraud detection, loyalty points validation, tax calculation, or currency conversion. Other examples of micro-services will now occur to those skilled in the art. Engines 136 typically operate independently, and can be directed by orchestrator engine 120 to coordinate handling of different aspects of transaction messages related to interactions between client devices 116 and travel actor engines 104, such as fulfillment of itinerary bookings.

As will be explained in greater detail below, orchestrator engine 120 can thus communicate with micro-service engines 136 to dynamically invoke and manage the appropriate services as needed. Orchestrator engine 120 can select and sequence micro-service engines 136 based on transaction parameters, system load, and service availability to optimize processing of transaction messages. Furthermore, micro-service engines 136 can be scalable and/or distributed across different geographic locations or data centers, for redundancy and system performance enhancement for global operations.

Travel actor engines 104 can be based on any present or future electronic servers or computing architectures that, amongst other things, manage electronic bookings for transportation, accommodation, meals and/or any other booking functions associated with travel.

For instance, transportation travel actor engines 104 can handle reservations for airlines, trains, car rentals, and ride-sharing services. These engines 104 can interface with various providers and systems such as Global Distribution Systems (GDS) like Amadeus™, Sabre™, and Travelport™, which aggregate booking information from multiple airlines. Additionally, they can utilize the New Distribution Capability (NDC) standards for direct connections to airlines, enabling more customized and dynamic offerings. Aggregator sites like Expedia™ and Kayak™ can also be integrated to provide a comprehensive view of available travel options.

Accommodation travel actor engines 104 can manage reservations for hotels, vacation rentals, and other lodging options. These engines can connect with hotel chains (e.g., Marriott™, Hilton™), online travel agencies (e.g., Booking.com™, Expedia™), and home-sharing platforms (e.g., Airbnb™, VRBO™) to facilitate seamless booking experiences for travelers. By aggregating data from these sources, the engines can offer a wide range of accommodation choices and ensure real-time availability and pricing.

Meal booking travel actor engines 104 can coordinate dining reservations and meal plans, integrating with restaurant reservation systems (e.g., OpenTable™, Resy™) and catering services to provide travelers with convenient dining options. These engines ensure that travelers can easily book tables at their preferred restaurants or arrange for meal services during their trips, enhancing the overall travel experience.

Orchestrator engine 120 can be any type of electronic server or computing architecture that facilitates coordination of the other nodes of system 100, particularly in the context of managing micro-service engines 136 as part of transaction messages that reflect interactions between client devices 116 and travel actor engines 104.

Client devices 116 can be any type of human-machine interface for interacting with orchestrator engine 120. For example, client devices 116 can include traditional laptop computers, desktop computers, mobile phones, tablet computers and any other device that can be used to receive and send content that complement the input and output hardware devices associated with a given client device 116. It is contemplated client devices 116 can include virtual or augmented reality gear complementary to virtual reality or augmented reality or “metaverse” environments that can be offered on collaboration engines 104. Client devices 116 can be operated by different users 124 that are associated with a respective identifier object 128 that uniquely identifies a given user 124 accessing a given client device 116 in system 100.

Administrator terminal 118 can also be any type of human-machine interface of the same types as client devices 116. Administrator terminal 118 is operated by an administrator 126. In a present embodiment, there is one administrator terminal 118 for all travel actor engines 104 and all client devices 116. In variants, when system 100 is scaled, a plurality of administrator terminals 118 can be provided that are respective to one or more travel actor engines 104 and/or a plurality of administrator terminals 118 can be provided that are respective to one or more client devices 116.

The present specification contemplates scenarios where users 124 may wish to search for electronic travel itineraries via one or more travel actor engines 104 that store and/or compute such electronic itineraries, particularly where there are specific constraints and/or preferences for different users 124. At the same time, the specification also contemplates orchestrator engine 120 managing engines 136 on behalf of client devices 116 and travel actor engines 104.

Thus, administrator 126 operates administrator terminal 118 which receives input representing configuration datasets defining parameters that shape travel booking search queries from client devices 116 directed at travel actor engines 104. Administrator 126 can be, for example, a representative of the human resources department of an enterprise that employs users 124 and establishes travel directives and/or policies. It is to be understood, however, that these human factors are provided for fullness of the description and for context for implementation of the present teachings, but the technical teachings herein are directed to the purpose of, amongst other things, reducing wasted searches on travel actor engines 104, and increasing alignment between searches and actual bookings.

Accordingly, client devices 116 are based on any suitable client computing platform operated by users 124 that may have an interest in the content being provided by engines 104. Each device 116 and its user 124 is thus typically associated with a user identifier object 128, particularly if any booking functions are to be utilized.

A person of skill in the art is to recognize that the form of an identifier object 128 is not particularly limited, and in a simple example embodiment, can be simply an alpha-numerical sequence that is entirely unique in relation to other identifier objects in system 100. Identifier objects can also be more complex as they may be combinations of account credentials (e.g. user name, password, Two-factor authentication token, etc.) that uniquely identify a given user 124. Identifier objects themselves may also be indexes that point to other identifier objects, such as one or more accounts. The salient point is that they are uniquely identifiable within system 100 in association with what they represent. Identifier objects 128 can include profiles and other demographic information associated with its respective users 124 which can be used as part of a transaction message orchestration.

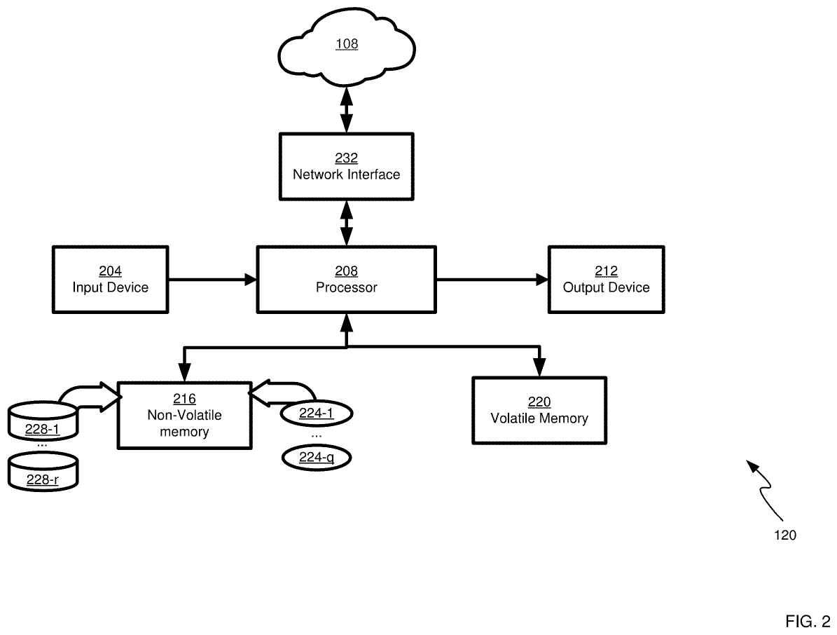

Having described an overview of system 100, it is useful to comment on the hardware infrastructure of system 100. FIG. 2 shows a schematic diagram of a non-limiting example of internal components of orchestrator engine 120.

In this example, orchestrator engine 120 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or may be omitted altogether as the context requires.

As will be explained in greater detail below, in general terms, orchestrator engine 120 is configured to coordinate and execute search queries and booking requests of travel actor engines 104 from a given user 124 by dynamically applying user-specific constraints and preferences. This involves prioritizing these constraints, thereby reducing the computational load on travel actor engines 104. The orchestrator engine 120 processes input from client devices 116 and such that resulting search queries align with both the user-specific constraints and the broader policies set by administrator terminal 118.

Processor 208 may be implemented as a plurality of processors or one or more multi-core processors. The processor 208 may be configured to execute different programming instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 may also be described as a non-transitory computer readable media. Non-volatile memory 216 may be used as a cache for caching. Also, more than one type of non-volatile memory 216 may be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated. Volatile memory 220 may also be used as a cache for caching.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224.

The infrastructure of orchestrator engine 120, or a variant thereon, can be used to implement any of the computing nodes in system 100, including travel actor engines 104, orchestrator engine 120 and micro-service engines 136. In variants, orchestrator engine 120 can be incorporated directly into one or more travel actor engines 104, resulting in one or more orchestrator engines 120 respective to various travel actor engines 104, where each orchestrator engine 120 is configured to orchestrate transaction messages between micro-service engines 136 and its respective travel actor engines 104.

By the same token, a plurality of orchestrator engines 120 independent from travel actor engines 104 may be provided. Overall, the engines 104 and/or engine 120 and/or micro-service engines 136 and other nodes in system 100 may be implemented using cloud computing platforms such as Microsoft Azure™ or Amazon Web Services (AWS)™.

Furthermore, one or more of the engine nodes in system 100 (e.g. orchestrator engine 120, travel actor engines 104, micro-service engines 136) may also be implemented as virtual machines and/or with mirror images to provide load balancing.

A person of skill in the art will recognize that the core elements of processor 208, input device 204, output device 212, non-volatile memory 216, volatile memory 220 and network interface 232, as described in relation to the server environment of orchestrator engine 120, have analogues in the different form factors of client machines such as those that can be used to implement client devices 116 and administrator terminal 118. Again, client devices 116 can be based on computer workstations, laptop computers, tablet computers, mobile telephony devices or the like.

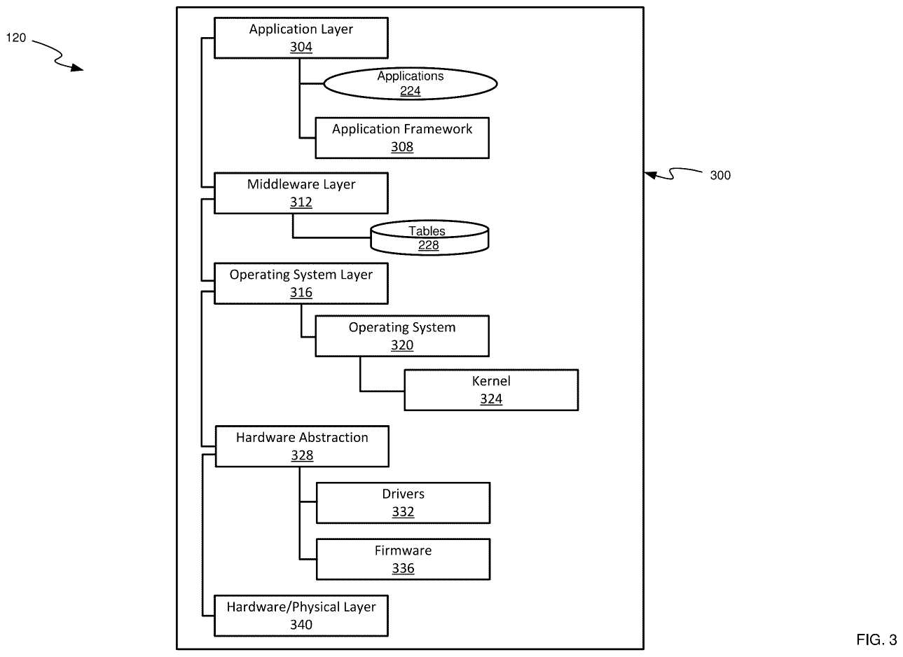

FIG. 3 provides another schematic representation of orchestrator engine 120, including detailed view of a stack 300 employed in the computing environment of orchestrator engine 120. The stack 300 is structured to depict the different layers involved in the operation orchestrator engine 120, from the application layer 304 down to the physical hardware layer 340 of orchestrator engine 120.

At the highest level, the application layer 304 encompasses the various applications 224 and application frameworks 308. Applications 224 represent the end-user software programs such as web browsers, email clients, and office suites that perform specific tasks. Application frameworks 308 include the libraries and frameworks that facilitate application development, such as .NET, Spring, and Django.

Beneath the application layer is the middleware layer 312, which includes tables 228 and other middleware components. Middleware serves as an intermediary that provides common services and capabilities to applications outside of what the operating system offers. Examples include database management systems, web servers (e.g., Apache, Nginx), and application servers (e.g., Tomcat).

The operating system layer 316 is composed of the operating system 320 and kernel 324. The operating system 320 is the system software that manages hardware resources and provides essential services to computer programs. The kernel 324 is the core part of the operating system, responsible for managing system resources and facilitating communication between hardware and software components.

The hardware abstraction layer 328 includes drivers 332 and firmware 336. Drivers 332 are software components that enable the operating system 320 and other software to communicate with hardware devices shown in FIG. 2. Examples include device drivers for input device 204, output device 212 and network interface 232. Firmware 336 can software programmed into hardware devices of physical hardware layer 340 to provide low-level control and communication.

At the base of the stack is the hardware and physical layer of orchestrator engine 120, encompassing the physical hardware components such as the input device 204, processor 208, non-volatile memory 216, volatile memory 220 and network interface 232.

Stack 300 illustrates how different layers interact within a computing environment of orchestrator engine 120, enabling the execution of various applications 228 and services such as applications 224. Each layer can interact with the layer below it to function correctly, and together they form a cohesive system that powers the computing capabilities of devices such as those used in the orchestrator engine 120, travel actor engines 104, client devices 116 and other nodes of system 100.

The stack 300 in FIG. 3 can be applied to various computing environments including other hardware nodes in system 100, including server infrastructures for engines 104, orchestrator engine 120 and micro-service engines 136 as well as client devices 116 and administrator terminal 118. Whether implemented in a traditional server environment or as virtual machines on cloud computing platforms like Microsoft Azure or Amazon Web Services (AWS), the described layers of stack 300 provide a framework for managing and executing software applications such as applications 224 and middleware layers 312 such as databases 228.

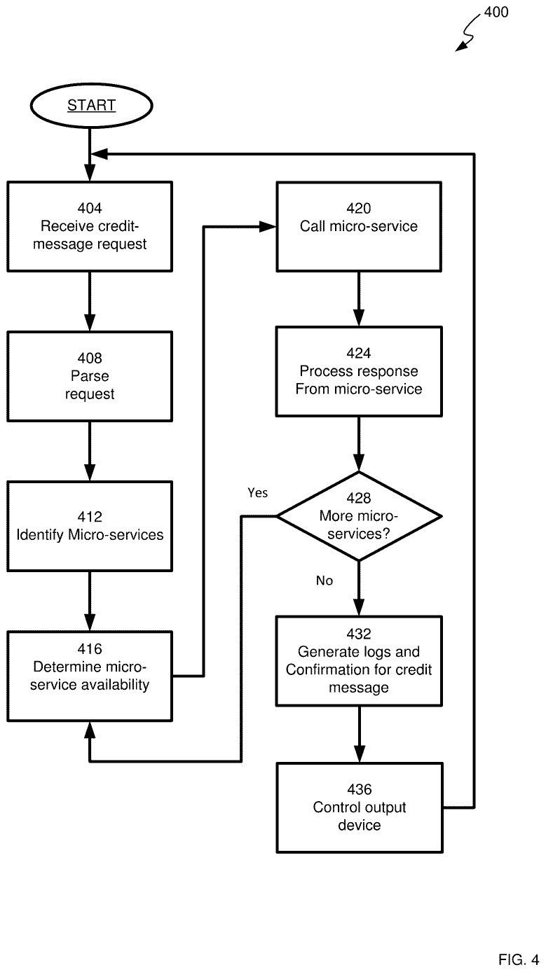

FIG. 4 shows a flowchart depicting a method for transaction message orchestration indicated generally at 400. Method 400 can be implemented on system 100. Persons skilled in the art may choose to implement method 400 on system 100 or variants thereon, or with certain blocks omitted, performed in parallel or in a different order than shown. Method 400 can thus also be varied. However, for purposes of explanation, method 400 will be described in relation to its performance on system 100 with a specific focus on treating method 400 as, for example, application 224-1 maintained within orchestrator engine 120 and its interactions with the other nodes in system 100.

Block 404 comprises receiving a credit-message request from one of the client devices 116. The credit-message arrives in the context of completing a travel itinerary booking between, for example client device 116-1 and travel actor engine 104-1. Such bookings typically occur toward the conclusion of a search session that first builds the itinerary and then proceeds to payment processing. Thus the credit-message relates to one or more aspects of the payment processing. However, since actual payments are typically managed through financial institution servers (not shown), micro-service engines 136 thus intermediate to facilitate the payment processing on behalf of client device 116-1 and travel actor engine 104-1.

The credit-message request may be in the form of a structured electronic message such as an application programming interface (API) call. This request triggers the orchestrator engine 120 to begin processing the credit-message transaction, setting off the subsequent steps in the orchestration process. This message contains data pertaining to the transaction, including relevant account information for a given user 124 (e.g. user 124-1) via a respective user identifier object 128 (for example identifier object 128-1), and indicating a payment method (credit card, debit card, gift card), and/or use of loyalty points.

Block 408 comprises parsing the received credit-message request. The parsing operation extracts key data from the request, including the transaction parameters such as payment details, loyalty points, and any additional metadata such as might be contained within identifier object 128. The extracted data identifies which micro-services engines 136 can be used to process the relevant portion of the credit-message request. This parsing can involve, for example, normalization checking for formatting consistency, so that the input adheres to expected protocols such as JSON or XML, and otherwise formatting the parsed-portion into an expected API format respective to a relevant micro-service engine 136.

Block 412 comprises identifying the relevant micro-service engine 136 to process the relevant portion of the credit-message request. Based on the parsed request data, the orchestrator engine 120 can determine which micro-services engines 136 can fulfill the transaction. For instance, if the transaction involves both a credit card payment and the use of loyalty points, the orchestrator engine 120 can select a payment authorization micro-service engine 136 (e.g. micro-service engine 136-1) and a relevant loyalty point micro-service engine 136 (e.g. micro-service engine 136-2).

To elaborate, example payment authorization micro-service engines 136 can include those that handle traditional payment methods, such as credit cards (e.g., Visa, Mastercard, American Express), debit cards, and alternative payment methods such as bitcoin or digital wallets (e.g., Apple Pay, Google Pay). For loyalty programs, micro-service engines 136 may validate and apply loyalty points from airlines, hotels, or other rewards programs (e.g., micro-service engine 136-2 could handle frequent flyer miles from a specific airline, or hotel points from a chain like Hilton).

Further, depending on the transaction type, other micro-services engines 136 may be called upon. For instance, in transactions involving international travel, currency conversion micro-service engines 136 may be invoked to ensure accurate payment in the correct currency. Similarly, tax calculation micro-service engines 136 could be leveraged to ensure that the correct tax rates are applied, especially in transactions that cross state or national borders.

Fraud detection micro-service engines 136 can be engaged when necessary, applying machine learning or rule-based algorithms to detect potentially fraudulent transactions in real time. These fraud detection services can cross-reference the credit-message request with user behavior, past transactions, or external risk databases to flag suspicious activities. Additionally, micro-services 136 that handle compliance with regulatory frameworks, such as ensuring adherence to Know Your Customer (KYC) rules or processing Anti-Money Laundering (AML) checks, may also be involved based on the parsed transaction data.

The decision on which micro-services 136 are identified at block 412 can thus be based on the content of the credit-message request, as parsed at block 408, and may vary dynamically, depending on the context, user profile, and transaction-specific data. This dynamic identification and coordination of micro-services is a key feature of the orchestrator engine 120, enabling it to efficiently process complex transactions with multiple components.

Block 416 comprises determining micro-service availability. At this stage, the orchestrator engine 120 can, for example, query each of the identified micro-service engines 136 to determine their current availability status. This may involve, for example, checking parameters such as system load, response times, and whether any of the service engines 136 are temporarily down for maintenance. The potential for selecting another micro-service engine 136 is contemplated if it can fulfill the same request if a first micro-service engine 136 is otherwise unavailable. The orchestrator engine 120 may further assess priority, particularly in the case of high-volume transaction environments, as described in relation to method 500 discussed further below. Based on this analysis, the orchestrator engine 120 can select one or more optimal micro-services engines 136 for the processing the relevant portion of the parsed credit-message request.

Block 420 comprises calling the identified micro-services. Once the appropriate micro-services engines 136 have been identified and their availability confirmed, the orchestrator engine 120 issues requests to the selected engines 136, making use of APIs and tailoring those requests according to APIs respective to the selected engines 136. Such requests contain the relevant transaction data and parameters for each respective micro-service to process. For example, a payment authorization engine associated with a given micro-service engines 136 (e.g. micro-service engine 136-1) can receive the credit card details associated with identifier object 128-1, while the loyalty points validation engine (e.g. micro-service engine 136-2) processes the loyalty program information associated with identifier object 128-1.

Block 424 comprises processing the response from each micro-service engine 136. As each micro-service engine 136 completes its processing task, it sends a response back to the orchestrator engine 120. The orchestrator engine 120 collects and processes these responses, ensuring that each micro-service operation was successfully executed. For example, the payment authorization micro-service engine 136-1 may return a success or failure status for the credit card transaction, while the loyalty points micro-service engine 136-2 returns the number of points successfully applied to the transaction.

Block 428 comprises determining whether more micro-services are required. This decision point evaluates whether the orchestration process needs to call any additional micro-services to complete the transaction. For example, a successful payment authorization might require follow-up fraud detection or tax calculation micro-services to be invoked. As another example, an unsuccessful payment authorization may lead to automatically trying a backup payment type stored in identifier object 128-1, ultimately resulting in a call to another micro-service engines 136 (e.g. micro-service engine 136-3 associated with a backup payment method). If more micro-services are needed, the orchestrator returns to block 416 and method 400 continues again through to block 428 until a “yes” determination is reached at block 428. (Note that a “yes” determination may still be reached at block 428 even if there was a failure to complete the credit-message request resulting in a failure to complete the itinerary booking; the “no” determination at block 428 basically being reserved for retries or backups.)

Block 432 comprises generating logs and confirmation for the credit message. Once all necessary micro-services have completed their operations, the orchestrator engine 120 can generate logs detailing the entire transaction flow. These logs can be stored for record-keeping and potential auditing purposes. The logs can also be used for machine learning operations to ascertain which combinations of micro-service engines 136 result in fastest and/or reduced resource consumption of system 100, and to utilize that machine learning in subsequent invocation of method 400 to make efficient use of system 100. Additionally, a confirmation message is prepared and sent to the requesting client device 116, indicating the status of the transaction, whether it was successful or failed.

Block 436 comprises controlling an output device based on the transaction results. In some scenarios, the orchestrator engine 120 may need to trigger an output device, such as an external display, payment receipt printer, or initiating a process in a travel actor engine 104, depending on the outcome of the transaction. The nature of this output is specific to the application and the context in which the orchestrator engine 120 is operating.

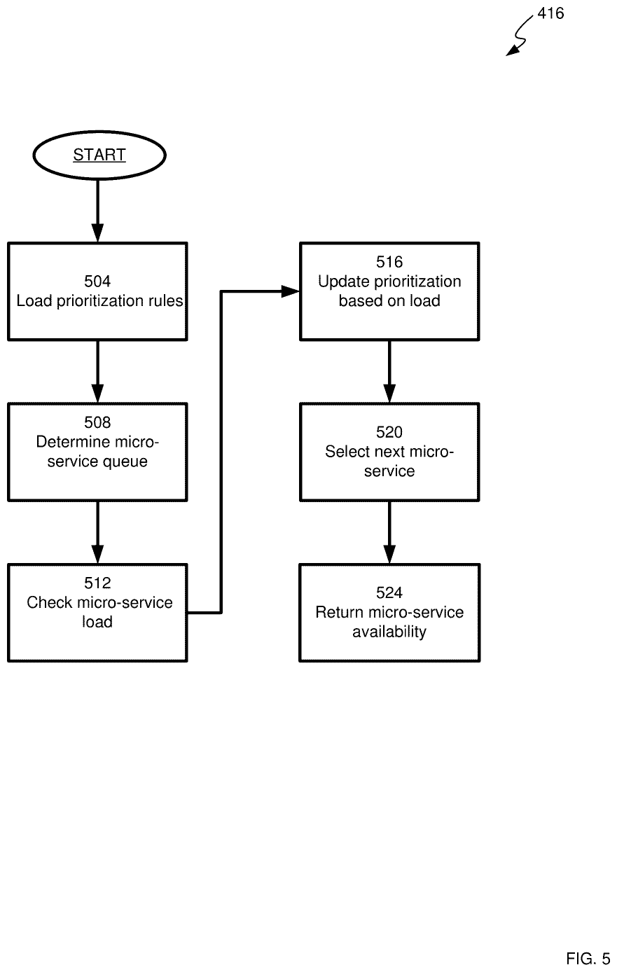

FIG. 5 shows a flowchart depicting a method for determining micro-service prioritization indicated generally at 500. In a present embodiment, method 500 can be implemented within block 416 of method 400. In variants, however, method 500 can be implemented between block 412 and block 416. Other ways of varying method 400 and method 500, such as their sequence of operation, whether blocks are performed in parallel, etc. will occur to those of skill in the art. In general terms, method 500 serves to prioritize which micro-service engine 136 is selected and the order in which these engines 136 are invoked, based on the transaction parameters and system conditions.

Block 504 comprises loading prioritization rules. These rules may be pre-configured based on factors such as the type of transaction, user preferences, historical behavior, or business policies. For example, in a loyalty points redemption scenario, the prioritization rules may dictate that loyalty points are used first before any form of monetary payment is processed. In other cases, particularly when a user's loyalty point balance is insufficient to cover the entire transaction, the rules may dictate that a partial redemption occurs before invoking a secondary payment method such as a credit card.

Additionally, different combinations of travel actor engines 104, identifier objects 128, and micro-service engines 136 may influence prioritization rules. For example, consider a scenario where travel actor engine 104-1 corresponds to Air France, and identifier object 128-1 is associated with user 124-1, who holds a Visa card issued by an American bank and a loyalty points card affiliated with an airline partner of Air France. In contrast, travel actor engine 104-2 corresponds to Air Canada, and identifier object 128-2 is associated with user 124-2, who holds a Mastercard issued by a Canadian bank and loyalty points with Air France. The prioritization rules may differ between these cases. For instance, in the first scenario, the Visa card might be prioritized first, with the Air France loyalty points used second, whereas in the second scenario, the Air France loyalty points might be prioritized first, followed by the Mastercard. These examples illustrate how prioritization rules can dynamically adjust based on user profiles, payment methods, and travel actor configurations. A skilled reader will now appreciate how these prioritization rules can vary in a myriad of other ways, given the number of potential client devices 116, travel actor engines 104 and micro-service engines 136 are involved with a globally scaled version of system 100, and the virtually infinite number of combinations of credit message requests that can arise.

A person skilled in the art will recognize that the orchestration of prioritization rules at this scale cannot managed by human intervention, particularly when it comes to efficient utilization of computing and network resources of system 100, given the vast number of potential combinations involving client devices 116, travel actor engines 104, and micro-service engines 136 in system 100, and the fact that credit-message requests need to coexist with each other as well as other traffic carried over network 108. The volume of transactions, each presenting unique combinations of user profiles, payment methods, and loyalty configurations, leads to an exponentially growing set of potential interactions that the orchestrator engine 120 must process. Prioritization rules at block 504 can thus be dynamically adjusted to account for system load, transaction-specific parameters, and user-specific configurations in a manner that optimizes the overall performance of the system.

Notably, orchestrator engine 120 can be configured to leverage prioritization rules to distribute requests across micro-service engines 136 in real-time, thereby minimizing response times and reducing strain of resources in system 100. Dynamic allocation of resources based on prioritization rules can improve bandwidth efficiency, reduce latency, and otherwise faster processing of credit message requests. The ability of the orchestrator engine 120 to assess and adapt to conditions of system 100, while simultaneously managing an array of transaction variables, results in a significant improvement over static systems or manual intervention, which lack the capacity to respond dynamically to varying workloads and network conditions of system 100.

Thus, the prioritization mechanism provides one of the clear technical benefits of the present specification. The prioritization mechanism can streamline transaction flows and also ensures the optimal use of computational and network resources. By automating the decision-making process regarding which micro-service engines 136 to engage and in what order, orchestrator engine 120 can reduce bottlenecks, resource wastage, and otherwise maintain smooth operation even under heavy transaction loads.

Additionally, the ability of orchestrator engine 120 to dynamically reallocate resources based on real-time performance metrics and historical performance of method 400 can overall result in efficient operation of system 100. This enhances the overall scalability and robustness of system 100, offering concrete improvements in terms of processing speed, system throughput, and resource utilization. The orchestrator engine 120 thus contributes to a tangible technical effect, providing efficiencies that extend beyond the mere execution of business-related tasks and into the underlying technical infrastructure responsible for handling and processing these requests.

Block 508 comprises determining the micro-service queue. The orchestrator engine 120 creates or updates a queue of the relevant micro-service engines 136, as identified in block 412 of method 400. This queue represents the sequence in which these micro-service engines 136 will be invoked. For instance, if the transaction involves both loyalty points and a credit card payment, the queue may list a loyalty point validation engine (e.g., micro-service engine 136-2) followed by a payment authorization engine (e.g., micro-service engine 136-1). In the case where the transaction requires additional services, such as fraud detection, that service may be placed at the appropriate position in the queue, either before or after payment authorization.

Block 512 comprises checking the load on each micro-service engine 136. The orchestrator engine 120 queries each of the micro-service engines 136 to determine the current system load. This may include factors such as the number of active requests being processed by a given engine 136, response times, or whether the engine 136 is temporarily unavailable. This load-checking mechanism can allow orchestrator engine 120 to optimize the selection of engines 136, avoiding or reducing overloading or delays that might result from invoking a busy micro-service engine 136. If a particular engine 136 is under heavy load, the orchestrator engine 120 may consider reprioritizing the sequence or selecting an alternate engine 136 that can fulfill the same function, if available.

Block 516 comprises updating the prioritization rules based on the load information. After assessing the load on each micro-service engine 136, the orchestrator engine 120 may dynamically adjust the prioritization. For example, if the payment authorization micro-service engine 136-1 is under significant load, but the loyalty point validation engine 136-2 is available with minimal load, the orchestrator engine 120 may prioritize processing loyalty points first to reduce overall transaction time. This flexibility allows the system to dynamically adapt to changing conditions, ensuring efficient resource utilization and maintaining performance standards.

Block 520 comprises selecting the next micro-service engine 136 from the queue. Based on the prioritization rules and the current load conditions, the orchestrator engine 120 selects the next micro-service engine 136 for invocation. For instance, if loyalty points are to be processed first, the orchestrator engine 120 will identify the loyalty point validation engine 136-2. If payment authorization is prioritized, then the payment authorization engine 136-1 may be selected first. block520 operates in real-time, dynamically adapting to the availability and prioritization of the micro-service engines 136.

Block 524 comprises returning the selected micro-service engine 136 to block416. Once the prioritization and load balancing steps have identified the appropriate micro-service engine 136, the orchestrator engine 120 returns this selection to block416. This allows the orchestrator engine 120 to proceed with calling the micro-service engine 136 in block 420, ensuring that the next transaction step is handled by the appropriate service. The returned micro-service availability information ensures smooth orchestration by enabling real-time adjustments as transactions continue through method 400.

In view of the above, it will now be apparent that variants, combinations, and subsets of the foregoing embodiments are contemplated. For example, while block524 describes the returning of the selected micro-service engine 136 to block416 for subsequent processing, it is contemplated that other mechanisms for managing the invocation of micro-service engines 136 can be implemented. In some variants, the orchestrator engine 120 may utilize alternative processes for managing and updating micro-service availability, including batch processing, asynchronous updates, or predictive algorithms that anticipate future service load based on historical transaction patterns.

Additionally, in some variations, the orchestrator engine 120 can employ different prioritization methods or criteria that take into account geographic location, regulatory compliance, or user-specific preferences when selecting micro-service engines 136. For example, while block524 focuses on real-time selection and availability monitoring, in other variants, micro-service selection could be influenced by other factors such as micro-service performance history, risk profiles, or even energy consumption to optimize efficiency.

It is also contemplated that the orchestrator engine 120 could operate in a distributed architecture where multiple orchestrator nodes share micro-service availability data and transaction orchestration responsibilities. In this configuration, multiple instances of the orchestrator engine 120 could communicate and synchronize availability data of micro-service engines 136 across different regions or data centers to ensure optimal load balancing and prioritization at a global scale.

Moreover, variations in the system could involve returning availability data from micro-service engines 136 for longer-term monitoring or system-wide optimizations, such as trend analysis for improving micro-service efficiency or predicting system bottlenecks. This availability data may be fed into machine learning algorithms to optimize future orchestration decisions based on evolving transaction patterns, system load conditions, and external factors like network latency.

Furthermore, while block524 describes the immediate return of micro-service availability for orchestration of a current transaction, it is contemplated that in alternative implementations, micro-service availability could be cached or stored for future transactions, reducing the need for repetitive queries and improving the overall efficiency of the orchestration process in system 100. This could include preemptively updating availability data based on expected peak periods or high-traffic events, thus further enhancing system performance.

As discussed above, it is to be understood that one or more of the applications may include a machine learning studio platform with any desired related machine learning (ML) based algorithms and/or neural networks, and the like. The machine learning applications can utilize various algorithms, including but not limited to: generalized linear regression, random forest, support vector machine, gradient boosting regression, decision tree, generalized additive models, neural networks, deep learning, evolutionary programming, Bayesian inference, and reinforcement learning algorithms. Algorithms such as generalized linear regression, random forest, support vector machine, gradient boosting regression, decision tree, and generalized additive models may be preferred over neural networks, deep learning, and evolutionary programming algorithms.

To elaborate, the machine learning applications within orchestrator engine 120 may be configured to optimize several aspects of the transaction orchestration process. For example, by analyzing historical data across previous transactions, the system can predict which combinations of micro-service engines 136 are likely to provide the most efficient processing of credit-message requests. This may involve using gradient boosting regression to weigh the impact of various factors, such as transaction type, geographic location, or time of day, on system performance. Similarly, decision trees and random forest algorithms may be employed to evaluate the most optimal prioritization rules in real-time, continuously learning from system conditions to recommend dynamic adjustments that minimize latency or reduce bandwidth consumption.

Additionally, machine learning models can be used to predict system bottlenecks based on evolving transaction patterns. For instance, by analyzing prior transactions and micro-service load histories, reinforcement learning algorithms could preemptively adjust the prioritization rules, shifting the load among micro-service engines 136 before performance issues arise. These models could be trained on real-time data to dynamically reallocate resources, ensuring that orchestrator engine 120 maintains optimal system performance under fluctuating workloads.

Furthermore, neural networks and deep learning algorithms, while generally more resource-intensive, may be implemented in cases requiring advanced fraud detection or in analyzing complex transaction histories. In such implementations, the models can cross-reference user profiles, transaction metadata, and external data sources to identify anomalies or high-risk transactions. Once flagged, the system can dynamically reprioritize fraud detection micro-service engines 136 to reduce processing delays and mitigate security risks.

A person skilled in the art will appreciate that orchestrator engine 120 offers certain technical advantages by enabling seamless integration between travel actor engines 104 and diverse, geographically distributed payment systems. Traditionally, travel actor engines 104, such as those operated by airlines or hotels, face technical challenges when encountering unfamiliar or region-specific payment methods (e.g., WeChat Pay from China), which may not readily align with existing payment frameworks (e.g. Air Canada). Orchestrator engine 120 abstracts this complexity by dynamically invoking the necessary micro-service engines 136, which in turn integrate with different infrastructures for payment (and other related “check-out” transactions) to handle cross-border payments, enabling compatibility without requiring travel actor engines 104 to integrate foreign payment systems directly into their infrastructure.

This dynamic orchestration enhances technical interoperability across client devices 116 and travel actor engines 104, allowing travel actor engines 104 to process transactions across a wide array of payment methods without needing specific hardware or software upgrades. The ability of orchestrator engine 120 to invoke payment authorization, fraud detection, and compliance services through the micro-service architecture improves processing efficiency and reduces technical overhead, offering a solution to cross-border transaction issues that would otherwise require extensive hardware and software integration.

Furthermore, orchestrator engine 120 contributes to the overall scalability and robustness of system 100 by decoupling the infrastructure of travel actor engines 104 from the complexities of global payment integration. This modular approach allows system 100 and individual travel actor engines 104 to continually evolve as new payment protocols emerge, providing a future-proof solution that can adapt in real-time to new geographic or regulatory requirements.

The prioritization and dynamic resource management capabilities of orchestrator engine 120 further enhance system performance, optimizing bandwidth utilization, reducing latency, and ensuring efficient transaction processing. By assessing system load and adapting prioritization rules dynamically, orchestrator engine 120 can intelligently route requests to minimize bottlenecks and balance resource allocation across micro-service engines 136, even during peak transaction loads.

Overall, the orchestrator engine 120's combination of dynamic resource allocation, real-time system adaptability, and enhanced interoperability provides clear technical improvements. These enhancements enable more efficient management of cross-border transactions, reduce technical complexity for travel actors engines 104, and contribute to a scalable, flexible infrastructure capable of meeting the demands of a scaled number of client devices 116, travel actor engines 104 and micro-service engines 136.

It is to be reiterated that features and aspects of the various examples provided above can be combined into further examples that also fall within the scope of the present disclosure. In addition, the figures are not to scale and may have size and shape exaggerated for illustrative purposes.

1. A system for processing a credit-message request, the system comprising: an orchestration engine configured to receive a credit-message request; a parser configured to extract transaction details from the credit-message request; a micro-service identification module configured to identify one or more micro-services required to process the extracted transaction details; a micro-service availability module configured to determine the availability of the identified micro-services by: calling the selected micro-service to perform its respective function; processing the response received from the called micro-service; repeating the determining, calling, and processing for the remainder of the identified micro-services; a confirmation module configured to generate a confirmation for the processed credit-message request; and, an output device controller configured to control an output device based on the confirmation of the processed credit-message request.

2. The system of claim 1, wherein the micro-service availability module is further configured to: load prioritization rules for the micro-services; determine the queue status of each identified micro-service; assess the load on each identified micro-service; update the prioritization of the micro-services based on their current load and queue status; and, select the next micro-service to call based on the updated prioritization.

3. The system of claim 1, further comprising a prioritization adjustment module configured to dynamically adjust the prioritization rules based on one or more of real-time system load conditions, geographic location of the transaction, and transaction-specific parameters.

4. The system of claim 1, further comprising a prediction module configured to predict future network traffic bottlenecks based on historical transaction patterns and dynamically adjust the micro-service prioritization in anticipation of future demand.

5. The system of claim 1, wherein the parser is further configured to normalize the transaction details to a predefined format to ensure compatibility with the micro-service interfaces.

6. The system of claim 1, further comprising a machine learning module configured to analyze historical transaction data and adjust the prioritization rules to optimize resource utilization and minimize latency in subsequent transactions.

7. The system of claim 1, wherein the output device controller is further configured to generate and send an electronic message to a client device or administrator terminal indicating the status and results of the processed credit-message request.

8. The system of claim 1, wherein the micro-service availability module is further configured to: query each micro-service for system load, response time, and maintenance status; and, dynamically select an alternative micro-service if the first identified service is unavailable.

9. The system of claim 1, further comprising: a cache configured to store the availability status of one or more micro-services; and, a caching module configured to use the cached availability status during the determining step of a subsequent credit-message request such that fewer processing resources are used while processing the subsequent request.

10. The system of claim 1, further comprising a fraud detection module configured to invoke fraud detection micro-services to assess the risk profile of the transaction based on cross-referenced user behavior, transaction history, and external risk databases before completing the credit-message request.

11. A computer-implemented method for processing a credit-message request via an orchestration engine, the method comprising: receiving a credit-message request at the orchestration engine; parsing the received request to extract transaction details; identifying one or more micro-services required to process the extracted transaction details; determining the availability of the identified micro-services by: calling the selected micro-service to perform its respective function; processing the response received from the called micro-service; repeating the determining, calling, and processing for the remainder of the one or more micro-services; generating a confirmation for the processed credit-message request; and, controlling an output device based on the confirmation of the processed credit-message request.

12. The method of claim 11, wherein the determining comprises: loading prioritization rules for the micro-services; determining the queue status of each identified micro-service; assessing the load on each identified micro-service; updating the prioritization of the micro-services based on their current load and queue status; and, selecting the next micro-service to call based on the updated prioritization.

13. The method of claim 11, further comprising dynamically adjusting the prioritization rules based on one or more of real-time system load conditions, geographic location of the transaction, and transaction-specific parameters.

14. The method of claim 11, further comprising predicting future network traffic bottlenecks based on historical transaction patterns and dynamically adjusting the micro-service prioritization in anticipation of future demand.

15. The method of claim 11, wherein the parsing of the credit-message request includes normalizing the transaction details to a predefined format to ensure compatibility with the micro-service interfaces.
